(19) United States
(12) Patent Application Publication
(10) Pub. No.: US 2021/0377015 A1
(43) Pub. Date: Dec. 2, 2021

(54) NONINTERACTIVE MULTI AGENT KEY MANAGEMENT

(71) Applicant: Ing Bank N.V., Amsterdam (NL)

(72) Inventors: Antoine GIRARD, Amsterdam (NL); Herve FRANCOIS, Amsterdam (NL); Nicolas CAILLE, Amsterdam (NL); Rajesh SUBHANKAR, Amsterdam (NL); Amit PANDEY, Amsterdam (NL); Oleg BURUNDUKOV, Amsterdam (NL)

(73) Assignee: Ing Bank N.V., Amsterdam (NL)

(21) Appl. No.: 17/331,126

(22) Filed: May 26, 2021

Related U.S. Application Data
(60) Provisional application No. 63/030,540, filed on May 27, 2020.

(51) Int. Cl. H04L 9/08; H04L 9/32

(52) U.S. Cl. CPC H04L 9/0877; H04L 9/3247; H04L 9/0838; H04L 9/0825

(57) ABSTRACT

A private key management system (PKMS) that may include a first agent configured to receive a request from a client device; a distributed ledger shared between the first agent and multiple second agents such that the distributed ledger operates based on a consensus algorithm; a validation engine maintained by each of the first agent and the multiple second agents, the validation engine configured to query the distributed ledger to obtain data to verify the request; and a vault module maintained by each of the first agent and the multiple second agents, the vault module configured to perform a cryptography operation based on the request after the validation engine verifies the request.

### CROSS REFERENCE TO RELATED APPLICATIONS

This application claims priority to U.S. Provisional Application No. 63/030,540 filed May 27, 2020. The entirety of the above-listed application is incorporated herein by reference.

### FIELD

The present disclosure relates to noninteractive multi agent key management systems and methods.

### BACKGROUND

Private Key Management is a domain of IT Security that aims at safely dealing with the storage of secret material (keys), and cryptography operations (key generation, signing, encryption). Private keys can be used for asymmetric cryptography, a domain that has countless applications in IT systems (identity management, data confidentiality, digital signatures, encryption, blockchain). Many private key management systems (PKMS) rely on specialized hardware to store private key material such as hardware security modules (HSM). PKMS can focus on the secure lifecycle management of private keys for digital signatures and encryption operations, independently of any hardware or software technology it has been developed on.

Known HSMs can be dedicated hardware devices that store private key material and run cryptography operations with this key material. An important feature of HSM can be that the private keys are created in the device itself and they may not come out unencrypted. Such a system, while difficult, can be breached. Also, managing an HSM-based PKMS can incur high operational complexity and cost, as these HSMs have to be replicated across data centers to allow for maximum availability and reliability.

Known HSM-based PKMS are centralized by nature: the private key is in the box. This may lead to a single point of failure. Any successful attacks, physical damage, or random failures can result in leaking or losing the private key material. Moreover, access control and authentication to the HSM can be managed at the application level, making the HSM itself only as secure as the application using it. Indeed, if an attacker can access the application, he or she can effectively invoke functions on the HSM on the behalf of the application, in order to sign arbitrary data. In some HSM implementations, multiple approvals may be required from different users and roles before performing an operation in the HSM. This process can become complex and interactive as multiple users may have to decide if the operation is legitimate.

Known multi-party computation for threshold signatures (MPC-TS) is a PKMS that does not require hardware components. It can rely on modern cryptography building blocks (Homomorphic encryption, Zero Knowledge proofs) to store parts (shares) of the secret material on different systems (nodes). Moreover, it may include a threshold parameter T, to allow for a subset of all the nodes N, each having a share of the private key, to sign a given message (T-of-N). Depending on the type of asymmetric keys, an MPC decrypt operation can also be used, allowing for decrypting of messages encrypted with the public key. Such a distributed solution can be easier to maintain and operate than known HSMs because there is no dedicated hardware involved.

Known MPC-TS-based PKMS are distributed in that the private key is shared between multiple nodes, and these nodes can jointly run operations such as signing a message with the distributed private key. Among the known issues of MPC-TS is that all nodes should be able to independently decide if an input given to an operation (a message to be signed for example) is valid and can be executed. If MPC-TS nodes blindly sign any incoming message, the security benefits over an HSM-based solution can be diluted. Many MPC-TS-based PKMS perform their cryptography operations in an interactive and complex way such that a user at each node may decide if a message is authentic and can be processed.

The present disclosure provides systems and methods that improve upon the known HSM, MPC-TS and other similar private key management systems by overcoming the aforementioned issues.

### SUMMARY

The disclosed systems and methods improve PKMS, both HSM and MPC-TS-based by introducing a distributed validation logic that controls the access of the underlying private key material and making this validation non-interactive so that the system can operate with limited human intervention.

A private key management system (PKMS) is disclosed. The PKMS may include a first agent configured to receive a request from a client device; a distributed ledger shared between the first agent and multiple second agents such that the distributed ledger operates based on a consensus algorithm; a validation engine maintained by each of the first agent and the multiple second agents, the validation engine configured to query the distributed ledger to obtain data to verify the request; and a vault module maintained by each of the first agent and the multiple second agents, the vault module configured to perform a cryptography operation based on the request after the validation engine verifies the request.

In various exemplary embodiments, the request may include at least one claim and at least one command. The command of the request may be to update a current state of the distributed ledger. The command may be to generate a new private key. The command may be to decrypt a message with the private key. The command may be to sign a message with the private key. The claim of the request may include authentication data and/or policies that match the command.

In various exemplary embodiments, the consensus algorithm may require an agreement of at least a majority of agents to form a consensus. The distributed ledger may be a blockchain. Each of the agents may include an interface to interact with the client device and/or other agents. The vault module may be based on hardware security modules (HSM). The vault module may be based on multi-party computation for threshold signatures (MPC-TS).

A computer-implemented method for managing a private key management system (PKMS) is disclosed. The method may include: receiving, at a first agent, a request from a client device; querying a distributed ledger shared among the first agent and multiple second agents of the PKMS to obtain data to verify the request, wherein the distributed ledger operates based on a consensus algorithm; verifying, via the obtained data, the request at a validation engine maintained by each of the first agent and the multiple second agents; and after the verifying, performing a cryptography operation by a vault module based on the request, wherein the vault module is maintained by each of the first agent and the multiple second agents.

### BRIEF DESCRIPTION OF DRAWINGS

Other objects and advantages of the present disclosure will become apparent to those skilled in the art upon reading the following detailed description of exemplary embodiments, in conjunction with the accompanying drawings, in which like reference numerals have been used to designate like elements, and in which:

FIG. 1 shows a system for managing a private key according to an exemplary embodiment of the present disclosure;

FIG. 2 shows a sequence diagram for a state update request according to an exemplary embodiment of the present disclosure;

FIG. 3 shows a sequence diagram for a signature request via an MPC-TS-based vault according to an exemplary embodiment of the present disclosure;

FIG. 4 sequence diagram for a signature request via an HSM-TS-based vault according to an exemplary embodiment of the present disclosure;

FIG. 5 shows a flowchart for a method for managing a private key according to an exemplary embodiment of the present disclosure; and

FIG. 6 illustrates an exemplary machine configured to perform computing operations according to an embodiment of the present disclosure.

### DETAILED DESCRIPTION

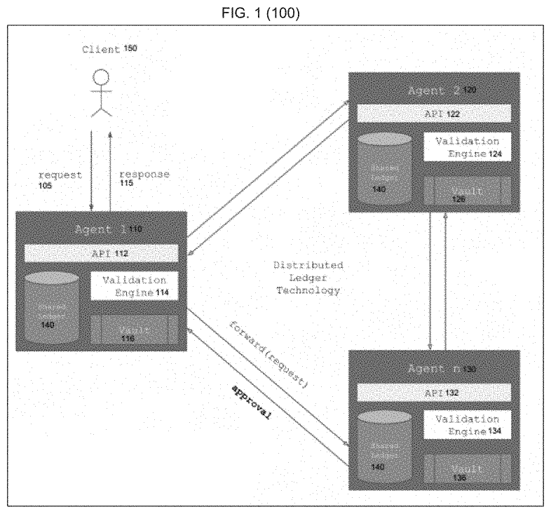

FIG. 1 shows system 100 for managing a private key. The system 100 may include multiple agents (e.g. 110, 120, 130) that share a distributed ledger (aka shared ledger) 140 on a peer-to-peer network. Each of the multiple agents can be a computer running an instance of the distributed ledger 140. An agent (e.g. 110) among the multiple agents can be configured to receive a request 105 from a client device 150, which may be any type of computer system, such as a desktop computer or handheld computing device. The client device 150 may connect with the agent 110 through a network.

The distributed ledger 140 can be operated based on a consensus algorithm that determines whether the request 105 is processed or ignored. The distributed ledger 140 can maintain a global state between the multiple agents in consensus. This state can be the same for all the agents. Data stored on the distributed ledger 140 can be used during validation of incoming requests. This data can be policy or users and roles, necessary to verify any claims in an incoming request.

In an exemplary embodiment, the consensus algorithm can be any protocol used to achieve agreement among the multiple agents on a single data value. Non-limiting examples of consensus algorithms include: Proof of Work (PoW), Practical Byzantine Fault Tolerance (PBFT), Proof of Stake (PoS), Proof of Authority, Proof of Elapsed Time, Paxos protocols, etc.

In an exemplary embodiment, the distributed ledger 140 can be a blockchain distributed among the multiple agents on a peer-to-peer network. Blockchain, as used herein, can be a ledger of all transactions of a blockchain-based data storage. One or more computing devices may comprise a blockchain network, which may be configured to process and record transactions as part of a block in the blockchain. Once a block is completed, the block can be added to the blockchain and the transaction record is thereby updated.

Blockchain may be a ledger of transactions in chronological order or may be presented in any order that may be suitable for use by the blockchain network. Blockchain may also include data as a form of transaction that maintains a continuously growing list of data records hardened against tampering and revision. The transaction may be confirmed and validated by the blockchain network through proof of work and/or any suitable verification techniques associated therewith. In some cases, data regarding a given transaction may further include additional data that is not directly part of the transaction appended to transaction data. In some instances, the inclusion of such data in a blockchain may constitute a transaction.

If at least a majority of agents agree with the request 105, the request 105 can be processed. The exact number of agents required for processing the request 105 may depend on the underlying implementation of the distributed ledger 140. For example, in some cases, a simple majority (over 50%) can suffice, in other cases a super majority (over 66%) may be required. The result of the processing can be, for example, to update the state of the distributed ledger 140, or to send events and trigger other actions, such as calling an HSM or initiating an MPC-TS process.

The request 105 can be an object or input given to the system 100 (via the agent 110) to be validated and processed by the multiple agents. The request 105 may include a command that tells the system 100 what should be done when processing this request (the command can itself be accompanied with arbitrary arguments). The request 105 may include a collection of claims that represent what should be validated against the command and the existing data on the distributed ledger 140 by the multiple agents of the system 100.

In an exemplary embodiment, the request 105 can be a command to generate a new private key by the system 100. This request, if valid, may trigger the generation of a new key, in the agent 110 that received the request 105 in the case of an HSM-based system, or initiate the MPC key generation protocol in the case of an MPC-TS-based system. The result may be a new private key present in the system 100 and the public key corresponding to this private key is returned to the client device 150.

In another exemplary embodiment, the request 105 can be a command to decrypt a message with an existing private key in the system 100. The message can be encrypted outside the system 100, using the associated public key. If the request 105 is valid, the decrypting process can be initiated and all agents should contribute by approving the operation. This can be done by signing it in their HSM for the initiating node to call the guarded decrypt function that requires multiple approvals from different users and roles before performing an operation. The decrypting operation can also be initiated via MPC-TS. The result may be the clear text message version of the encrypted message, returned to the client device 150. The result may be a signature generated by the corresponding private key, for a given message, returned to the client device 150.

In yet another exemplary embodiment, the request 105 can be a state update request with a command to update the current state of the distributed ledger 140. The purpose of a state update request can be to add new shared data to be used in the validation of subsequent requests. For example, adding a new policy or a new user that can approve requests resulting in a new shared ledger state. Other examples of the request 105 are described in detail subsequently in the disclosure. A person of ordinary skill in the art would appreciate that the requests on the system 100 are not limited by the examples described herein and may include other similar requests.

Each of the multiple agents (e.g. 110, 120, 130) may include an application programming interface (API) (e.g. 112, 122, 132 respectively) as a client facing interface. The API may receive requests from a client and return a response after these requests have been either validated or rejected. For example, the API 112 may receive the request 105 from the client device 150 and return a response 115 back to the client device 150 after the request 105 has been either validated or rejected.

In an exemplary embodiment, each of the multiple agents (e.g. 110, 120, 130) may include a validation engine (e.g. 114, 124, 134 respectively) to query the distributed ledger 140 for obtaining data necessary to verify the request 105. For example, the validation engine 114 of agent 110 may validate the request 105 coming either directly from the client device 150 via the API 112, or requests coming from the other agents (e.g. 120, 130). The validation engine 114 can query the distributed ledger 140, maintained by all the agents, for data necessary to verify the claims present in the request 105. If requests are validated or rejected, the validation engine 114 may trigger the resulting logic, invoking call-backs or sending events to other systems, as well as returning the response 115 to the client device 150 via the API 112.

The validation of requests can be non-interactive. The distributed ledger 140 that the multiple agents run together ensures that the distributed ledger 140 contains data the multiple agents can trust to perform the validation. Human intervention may not be needed to approve a request, allowing fully automated processing. The agents may use identical validation routines and use the same data to base their request validation against. This data may be stored on the distributed ledger 140 and all agents can be in consensus as to what this data is and represent, providing trustable and resilient validation data points.

The validation logic can be implemented to enable quorum features, ensuring that a certain number (threshold) of agents need to agree on processing the request 105. This logic can be inherently dependent on the consensus algorithm of the distributed ledger 140. The threshold can be at least equal to a majority required for consensus between all agents, thereby preventing malicious activity.

The quorum features can achieve a higher availability, because even if a minority are down or act maliciously, the system 100 may continue to operate. The quorum features can allow the agents to be deployed in different geographical zones and decrease the global attack surface of the system 100 by having agents using different underlying infrastructure (hardware, operating systems, system packages).

The quorum features can enable threshold signing for HSM-based PKMS: each agent may operate an HSM and validate the incoming request, approving it by signing it in its HSM. If pre-defined number of agents approve, the requesting agent can then in turn sign the message in its HSM. Similarly, the quorum features can enable threshold signing for MPC-TS based PKMS by having a threshold parameter T to allow for a subset of all the nodes N, each having a share of the private key, to sign a given message (T-of-N).

In an exemplary embodiment, each of the multiple agents (e.g. 110, 120, 130) may include a vault module (e.g. 116, 126, 136 respectively) that may perform a cryptography operation based on a request after the request is verified. Such an operation may include, but is not limited to, generating a private key, signing data, and encrypting data. The vault module can be HSM-based or MPC-TS-based. For example, vault module 116 may perform an operation based on the request 105 after it's verified. The next few paragraphs describe such operations based on various types of requests.

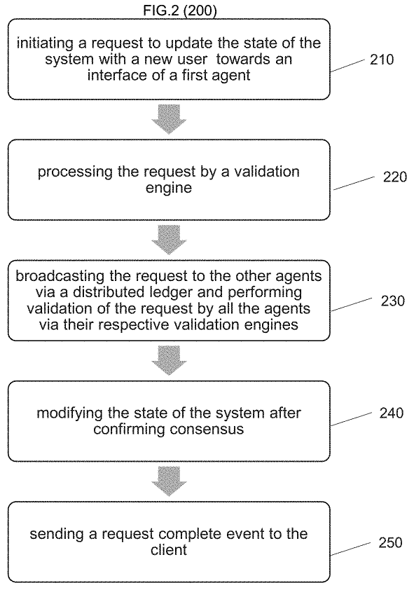

FIG. 2 shows a sequence diagram 200 for a state update request for a client (e.g. 150) that has two users (user1, user2) allowed to approve requests on a system (e.g. 100) but would like to add a third user (user3). The first step 210 may include initiating a request (e.g. 105) to an interface (e.g. 112) of a first agent (e.g. 110). The request may include a command to update the state of the system with a new user and include claims in form of approvals from the existing users (user1, user2). These claims can digital signatures or any form of authentication that the system is able to verify. The claims can also include policies that match the command.

The second step 220 may include the interface triggering the request processing by calling a validation engine (e.g. 114). The third step 230 may include the validation engine broadcasting the request to the other agents via a distributed ledger (e.g. 140) and performing validation of the request by all the agents via their respective validation engines. This can be done by querying data from the ledger about user1 and user2, to verify the users' approvals. Other validation, such as role check, request rate limit, etc. can also be done as part of step 230.

The fourth step 240 may include modifying the ledger state by adding third user (user3) as a request approver after confirming consensus in the validation under step 230. This step 240 may be performed by a vault module (e.g. 116) connected with the distributed ledger. The fifth step 250 may include sending a request complete event to inform the client that user3 has been granted access to approve new requests.

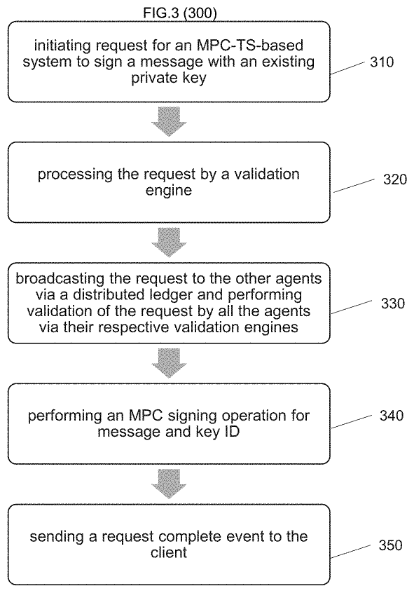

FIG. 3 shows a sequence diagram 300 for a signature request for an MPC-TS-based system with a command from a client (e.g. 150) to sign a message with an existing private key safely guarded by a system (e.g. 100). The first step 310 may include initiating a request (e.g. 105) towards an API (e.g. 112). The request may include a command to sign a given message “abcd” using private key ‘clientKey01’ and include claims are approvals from two client users (user2, user3).

The second step 320 may include the API triggering the request processing by calling a validation engine (e.g. 114). The third step 330 may include the validation engine broadcasting the request to the other agents via a distributed ledger (e.g. 140) and performing validation of the request by all the agents via their respective validation engines. This can be done by querying data from the ledger to verify the users' approvals. Other validation, such as checking ‘clientKey01’ belongs to the client can also be done as part of step 330.

The fourth step 340 may include initiating MPC signing operation for message and key ID, requesting the other agents (e.g. 120, 130) to participate. This happens after performing the validation under step 330 to confirm consensus for the validation of the request. Because agents have approved this operation beforehand, the signing can safely happen in a non-interactive manner. This signature may be recorded on the shared ledger for audit and traceability purposes. The fifth step 350 may include sending a request complete event to inform the client about the signing operation.

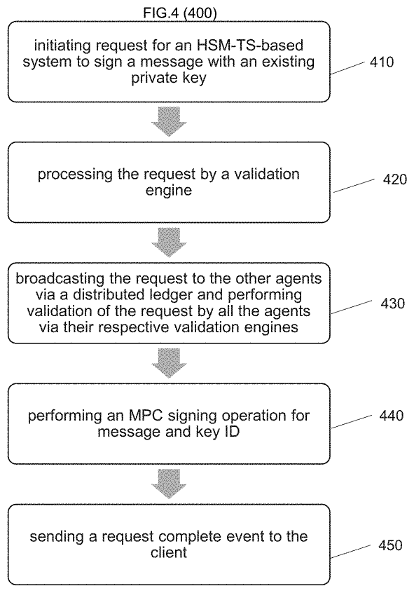

FIG. 4 shows a sequence diagram 400 for a signature request via an HSM-TS-based vault (e.g. 116) with a command from a client (e.g. 150) to sign a message with an existing private key safely guarded by a system (e.g. 100). The first step 410 may include initiating a request (e.g. 105) towards an API (e.g. 112). The request may include a command to sign a given message “abcd” using private key ‘clientKey02’ and include claims are approvals from two client users (user2, user3).

The second step 420 may include the API triggering the request processing by calling a validation engine (e.g. 114). The third step 430 may include the validation engine broadcasting the request to the other agents via a distributed ledger (e.g. 140) and performing validation of the request by all the agents via their respective validation engines. This can be done by querying data from the ledger to verify the users' approvals. Other validation, such as checking ‘clientKey02’ belongs to the client can also be done as part of step 430.

The fourth step 440 may include initiating HSM signing operation by peer agents (e.g. 120, 130) using ‘clientKey02’ and send the resulting signatures back to the initiating agent (e.g. 110). This happens after performing the validation under step 430 to confirm consensus for the validation of the request. The consensus can be formed when at least a majority of the agents have approved the request.

After the initiating agent has collected enough signatures from the peer agents, it can call a guarded signing function with message and key ID. This function can guarantee that the message is signed by clientKey02 only if enough peer agents have signed it as well. The signature can now be successfully created in a non-interactive manner. This signature may be recorded on the shared ledger for audit and traceability purposes. The fifth step 450 may include sending a request complete event to inform the client about the signing operation.

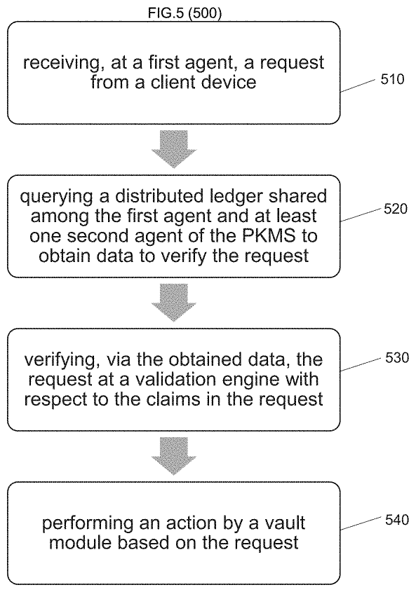

FIG. 5 shows a computer-implemented method 500 for managing a private key management system (PKMS). The method 500 may include a step 510 of receiving, at a first agent, a request from a client device. Aspects of the step 510 may relate to the previously described functionality of the agent 110 receiving the request 105.

The method 500 may include a step 520 of querying a distributed ledger shared among the first agent and the multiple second agents of the PKMS to obtain data to verify the request, wherein the distributed ledger operates based on a consensus algorithm. Aspects of the step 520 may relate to the previously described functionality of the distributed ledger 140.

The method 500 may include a step 530 of verifying, via the obtained data, the request at a validation engine maintained by each of the first agent and the multiple second agents. Aspects of the step 530 may relate to the previously described functionality of the validation engines. After the verifying, the method 500 may include a step 540 of performing a cryptography operation by a vault module based on the request, such that the vault module is maintained by each of the first agent and the multiple second agents. Aspects of the step 540 may relate to the previously described functionality of the vault modules.

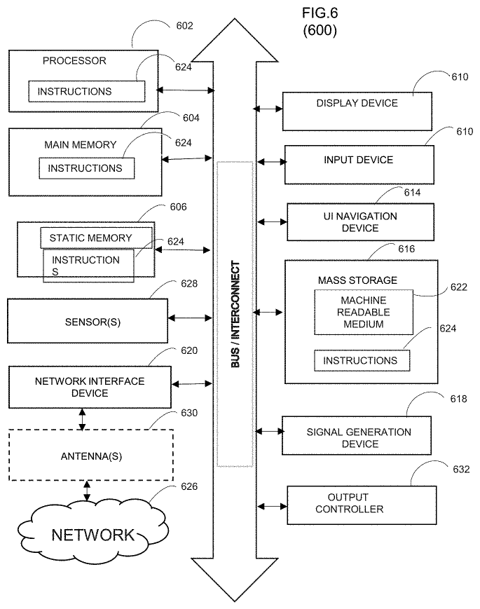

FIG. 6 is a block diagram illustrating an example computing system 600 upon which any one or more of the methodologies (e.g. system 100 and methods 200, 300, 400 and 500) discussed herein may be run according to an example described herein. Computer system 600 may be embodied as a computing device, providing operations of the components featured in the various figures of the present disclosure, including any processing or computing platform or component described or referred to herein. In alternative embodiments, the computing system 600 can operate as a standalone device or may be connected (e.g., networked) to other devices. In a networked deployment, the computing system 600 may operate in the capacity of either a server or a client machine in server-client network environments, or it may act as a peer machine in peer-to-peer (or distributed) network environments.

Example computing system 600 can includes a processor 602 (e.g., a central processing unit (CPU), a graphics processing unit (GPU) or both), a main memory 604 and a static memory 606, which communicate with each other via an interconnect 608 (e.g., a link, a bus, etc.). The computer system 600 may further include a video display unit 610, an alphanumeric input device 612 (e.g., a keyboard), and a user interface (UI) navigation device 615 (e.g., a mouse). In one embodiment, the video display unit 610, input device 612 and UI navigation device 615 are a touch screen display. The computer system 600 may additionally include a storage device 616 (e.g., a drive unit), a signal generation device 618 (e.g., a speaker), an output controller 632, and a network interface device 620 (which may include or operably communicate with one or more antennas 630, transceivers, or other wireless communications hardware), and one or more sensors 628.

The storage device 616 can include a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604, static memory 606, and/or within the processor 602 during execution thereof by the computer system 600, with the main memory 604, static memory 606, and the processor 602 constituting machine-readable media.

While the machine-readable medium 622 is illustrated in an example embodiment to be a single medium, the term “machine-readable medium” may include a single medium or multiple medium (e.g., a centralized or distributed database, and/or associated caches and servers) that store the one or more instructions 624. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, optical media, and magnetic media. Specific examples of machine-readable media include non-volatile memory, including, by way of example, semiconductor memory devices (e.g., Electrically Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 624 may further be transmitted or received over a communications network 626 using a transmission medium via the network interface device 620 utilizing any one of several well-known transfer protocols (e.g., HTTP). Examples of communication networks include a local area network (LAN), wide area network (WAN), the Internet, mobile telephone networks, Plain Old Telephone (POTS) networks, and wireless data networks (e.g., Wi-Fi, 3G, 4G and 5G, LTE/LTE-A or WiMAX networks). The term “transmission medium” shall be taken to include any intangible medium that can store, encoding, or carrying instructions for execution by the machine, and includes digital or analog communications signals or other intangible medium to facilitate communication of such software.

Other applicable network configurations may be included within the scope of the presently described communication networks. Although examples were provided with reference to a local area wireless network configuration and a wide area Internet network connection, it will be understood that communications may also be facilitated using any number of personal area networks, LANs, and WANs, using any combination of wired or wireless transmission mediums.

The embodiments described above may be implemented in one or a combination of hardware, firmware, and software. For example, the features in the system architecture 600 of the processing system may be client-operated software or be embodied on a server running an operating system with software running thereon. While some embodiments described herein illustrate only a single machine or device, the terms “system”, “machine”, or “device” shall also be taken to include any collection of machines or devices that individually or jointly execute a set (or multiple sets) of instructions to perform any one or more of the methodologies discussed herein.

Examples, as described herein, may include, or may operate on, logic or several components, modules, features, or mechanisms. Such items are tangible entities (e.g., hardware) capable of performing specified operations and may be configured or arranged in a certain manner. In an example, circuits may be arranged (e.g., internally or with respect to external entities such as other circuits) in a specified manner as a module, component, or feature. In an example, the whole or part of one or more computer systems (e.g., a standalone, client or server computer system) or one or more hardware processors may be configured by firmware or software (e.g., instructions, an application portion, or an application) as an item that operates to perform specified operations. In an example, the software may reside on a machine readable medium. In an example, the software, when executed by underlying hardware, causes the hardware to perform the specified operations.

Accordingly, such modules, components, and features are understood to encompass a tangible entity, be that an entity that is physically constructed, specifically configured (e.g., hardwired), or temporarily (e.g., transitorily) configured (e.g., programmed) to operate in a specified manner or to perform part or all operations described herein. Considering examples in which modules, components, and features are temporarily configured, each of the items need not be instantiated at any one moment in time. For example, where the modules, components, and features comprise a general-purpose hardware processor configured using software, the general-purpose hardware processor may be configured as respective different items at different times. Software may accordingly configure a hardware processor, for example, to constitute a particular item at one instance of time and to constitute a different item at a different instance of time.

Additional examples of the presently described method, system, and device embodiments are suggested according to the structures and techniques described herein. Other non-limiting examples may be configured to operate separately or can be combined in any permutation or combination with any one or more of the other examples provided above or throughout the present disclosure.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

Additionally, it should be noted that the terms “including” and “comprising” should be interpreted as meaning “including, but not limited to”.

In addition, it should be noted that, if not already set forth explicitly in the claims, the term “a” should be interpreted as “at least one” and “the”, “said”, etc. should be interpreted as “the at least one”, “said at least one”, etc.

Furthermore, it is the Applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A private key management system (PKMS) comprising:
a first agent configured to receive a request from a client device;
a distributed ledger shared between the first agent and multiple second agents such that the distributed ledger operates based on a consensus algorithm;
a validation engine maintained by each of the first agent and the multiple second agents, the validation engine configured to query the distributed ledger to obtain data to verify the request; and
a vault module maintained by each of the first agent and the multiple second agents, the vault module configured to perform a cryptography operation based on the request after the validation engine verifies the request.

2. The system of claim 1, wherein the request includes at least one claim and at least one command.

3. The system of claim 2, wherein the command is to update a current state of the distributed ledger.

4. The system of claim 2, wherein the command is to generate a new private key.

5. The system of claim 2, wherein the command is to decrypt a message with the private key.

6. The system of claim 2, wherein the command is to sign a message with the private key.

7. The system of claim 2, wherein the claim includes authentication data and/or policies that match the command.

8. The system of claim 1, wherein the consensus algorithm requires an agreement of at least a majority of agents to form a consensus.

9. The system of claim 1, wherein the distributed ledger is a blockchain.

10. The system of claim 1, wherein each of the agents include an interface to interact with the client device and/or other agents.

11. The system of claim 1 is based on hardware security modules (HSM).

12. The system of claim 1 is based on multi-party computation for threshold signatures (MPC-TS).

13. A computer-implemented method for managing a private key management system (PKMS), the method comprising:
receiving, at a first agent, a request from a client device;
querying a distributed ledger shared among the first agent and multiple second agents of the PKMS to obtain data to verify the request, wherein the distributed ledger operates based on a consensus algorithm;
verifying, via the obtained data, the request at a validation engine maintained by each of the first agent and the multiple second agents; and
after the verifying, performing a cryptography operation by a vault module based on the request, wherein the vault module is maintained by each of the first agent and the multiple second agents.

14. The method of claim 13, wherein the request includes at least one claim and at least one command.

15. The method of claim 14, wherein the command is to update a current state of the distributed ledger.

16. The method of claim 14, wherein the command is to generate a new private key.

17. The method of claim 14, wherein the command is to decrypt a message with the private key.

18. The method of claim 14, wherein the command is to sign a message with the private key.

19. The method of claim 14, wherein the claim includes authentication data and/or policies that match the command.

20. The method of claim 13, wherein the consensus algorithm requires an agreement of at least a majority of the agents to form a consensus.

21. The method of claim 13, wherein the distributed ledger is a blockchain.

22. The method of claim 13, wherein each of the agents include an interface to interact with the client device and/or other agents.

23. The method of claim 13 is based on hardware security modules (HSM).

24. The method of claim 13 is based on multi-party computation for threshold signatures (MPC-TS).
